(19) United States
(12) Patent Application Publication
(10) Pub. No.: US 2023/0395320 A1
(43) Pub. Date: Dec. 7, 2023

(54) INTEGRATED-TYPE COUPLED INDUCTOR AND RELATED MANUFACTURING METHOD

(71) Applicant: DARFON ELECTRONICS CORP., Taoyuan City (TW)

(72) Inventors: Chih-Ho Liu, Taoyuan City (TW); Jui-Wen Kuo, Taoyuan City (TW); Chi-Ming Huang, Taoyuan City (TW); Bo-Yu Huang, Taoyuan City (TW); Yao-Tsung Chen, Taoyuan City (TW)

(73) Assignee: DARFON ELECTRONICS CORP., Taoyuan City (TW)

(21) Appl. No.: 18/203,055

(22) Filed: May 29, 2023

Related U.S. Application Data
(60) Provisional application No. 63/348,024, filed on Jun. 2, 2022.

(30) Foreign Application Priority Data
Oct. 5, 2022 (TW) 111137814

(51) Int. Cl. H01F 41/04; H01F 27/29; H01F 27/06

(52) U.S. Cl. CPC H01F 41/04; H01F 27/29; H01F 27/06

(57) ABSTRACT

An integrated-type coupled inductor is applied to a related manufacturing method and includes a lead frame, a first coil, a second coil and a magnetic packing component. The lead frame has a first surface and a second surface opposite to each other and includes four pins. The first coil is disposed on the first surface and coupled to two of the four pins. The second coil is disposed on the second surface and coupled to other pins. The magnetic packing component covers the first coil and the second coil to expose parts of the four pins.

### CROSS REFERENCE TO RELATED APPLICATIONS

This application claims the benefit of U.S. Provisional Application No. 63/348,024, filed on Jun. 2, 2022. The content of the application is incorporated herein by reference.

### BACKGROUND OF THE INVENTION

### 1. Field of the Invention

The present invention relates to an inductor and related manufacturing method, and more particularly, to an integrated-type coupled inductor and related manufacturing method.

### 2. Description of the Prior Art

The conventional method of a ring-typed coil coupled to an inductor includes two types of double-wire winding and single-wire segmented winding. The coil is made by winding the ring-typed coil in several ways. For increasing the magnetic shielding function and mass production result, the conventional ring-typed coil coupled inductor is replaced by assembly-typed coupled inductor with the double-wire winding. With the miniaturization of products, the size of passive components is reduced and the distance between the passive components is shortened, the assembly-typed coupled inductor is difficult to assembly, and has drawbacks of insufficient magnetic shielding efficacy and easy magnetic saturation. The integrated-typed coupled inductor is made by soft magnetic powder and the coils, and has features of high magnetic shielding feature and uneasy magnetic saturation; however, the copper wire used in the double-wire winding has the insulating layer with high temperature resistance and high thickness, for preventing the insulating layer from being damaged by the soft magnetic powders. The coil made by the double-wire winding has the unstable length and cannot be applied for the conventional mechanical stripping process, and only the laser stripping process can be applied to remove the insulation layer and therefore have drawbacks of complicated manufacturing process and high cost.

### SUMMARY OF THE INVENTION

The present invention provides an integrated-type coupled inductor and related manufacturing method for solving above drawbacks.

According to the claimed invention, an integrated-type coupled inductor includes a lead frame, a first coil, a second coil and a magnetic packing component. The lead frame has a first surface and a second surface opposite to each other and includes four pins. The first coil is disposed on the first surface, and two ends of the first coil are respectively coupled to two of the four pins. The second coil is disposed on the second surface, and two ends of the second coil are respectively coupled to two other pins of the four pins. The magnetic packing component covers the first coil and the second coil to expose parts of the four pins.

According to the claimed invention, a manufacturing method applied to an integrated-type coupled inductor includes manufacturing and forming a first coil and a second coil, welding two ends of the first coil respectively to two pins on a first surface of a lead frame, welding two ends of the second coil respectively to two other pins on a second surface of the lead frame opposite to the first surface, and covering the first coil and the second coil via a magnetic packing component to expose parts of the four pins of the lead frame.

According to the claimed invention, an integrated-type coupled inductor includes a first inductor unit and a second inductor unit. A first coil is disposed inside the first inductor unit and two long pins with a first length are exposed. The second inductor unit is attached to the first inductor. A second coil is disposed inside the second inductor unit and two short pins with a second length are exposed, the second length is shorter than the first length, and the two long pins and the two short pins are bent to a bottom surface of the second inductor unit opposite to the first inductor unit.

According to the claimed invention, a manufacturing method applied to an integrated-type coupled inductor includes manufacturing and forming a first coil and a second coil, welding the first coil to two long pins of a lead frame and then utilizing a magnetic packing component to cover the first coil for forming a first inductor unit, welding the second coil to two short pins of the lead frame and then utilizing another magnetic packing component to cover the second coil for forming a second inductor unit, stacking the first inductor unit with the second inductor unit, and bending the two long pins and the two short pins to a bottom surface of the second inductor unit opposite to the first inductor unit. The long pin has a first length longer than a second length of the short pin.

The integrated-type coupled inductor and the related manufacturing method of the present invention can utilize the mechanical stripping process or the laser stripping process to remove the isolation layers of the first coil and the second coil. The coils without the isolation layer can be respectively welded to the pins of different holders in accordance with demands of each embodiment, and then soft magnetic powders, such as iron silicon chromium alloy, iron silicon alloy or amorphous alloy, can be utilized to form the magnetic packing component for accomplishing the integrated-type coupled inductor. The manufacturing method of the present invention can be used to manufacture the integrated-type coupled inductor for different circuit design, and have advantages of low cost and stable process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of parts of an integrated-type coupled inductor according to a first embodiment of the present invention.

FIG. 2 is a diagram of the integrated-type coupled inductor in another view according to the first embodiment of the present invention.

FIG. 3 is an appearance diagram of the integrated-type coupled inductor according to the first embodiment of the present invention.

FIG. 4 is a flow chart of an manufacturing method applied to the integrated-type coupled inductor according to the first embodiment of the present invention.

FIG. 5 is a diagram of parts of the integrated-type coupled inductor according to a second embodiment of the present invention.

FIG. 6 is an appearance diagram of the appearance diagram of the integrated-type coupled inductor according to the second embodiment of the present invention.

FIG. 7 is a flow chart of the manufacturing method applied to the integrated-type coupled inductor according to the second embodiment of the present invention.

FIG. 8 is a diagram of parts of the integrated-type coupled inductor according to a third embodiment of the present invention.

FIG. 9 is an appearance diagram of the appearance diagram of the integrated-type coupled inductor according to the third embodiment of the present invention.

FIG. 10 is a flow chart of the manufacturing method applied to the integrated-type coupled inductor according to the second embodiment of the present invention.

FIG. 11 is a diagram of parts of the integrated-type coupled inductor according to a fourth embodiment of the present invention.

FIG. 12 is a diagram of the integrated-type coupled inductor before assembly according to the fourth embodiment of the present invention.

FIG. 13 is an appearance diagram of the integrated-type coupled inductor according to the fourth embodiment of the present invention.

FIG. 14 is a flow chart of the manufacturing method applied to the integrated-type coupled inductor according to the fourth embodiment of the present invention.

FIG. 15 is a diagram of parts of the integrated-type coupled inductor according to a fifth embodiment of the present invention.

FIG. 16 is an appearance diagram of the integrated-type coupled inductor according to the fifth embodiment of the present invention.

FIG. 17 is a flow chart of the manufacturing method applied to the integrated-type coupled inductor according to the fifth embodiment of the present invention.

FIG. 18 is a diagram of parts of the integrated-type coupled inductor according to a sixth embodiment of the present invention.

FIG. 19 is an appearance diagram of the integrated-type coupled inductor according to the sixth embodiment of the present invention.

FIG. 20 is a flow chart of the manufacturing method applied to the integrated-type coupled inductor according to the sixth embodiment of the present invention.

### DETAILED DESCRIPTION

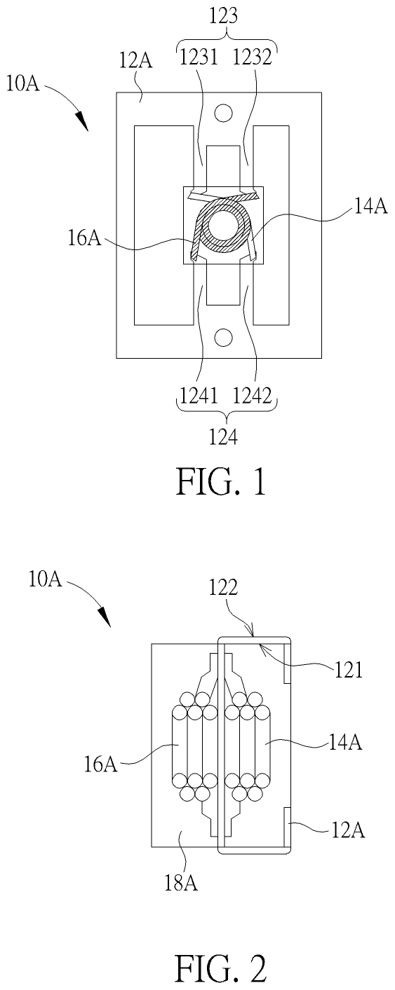

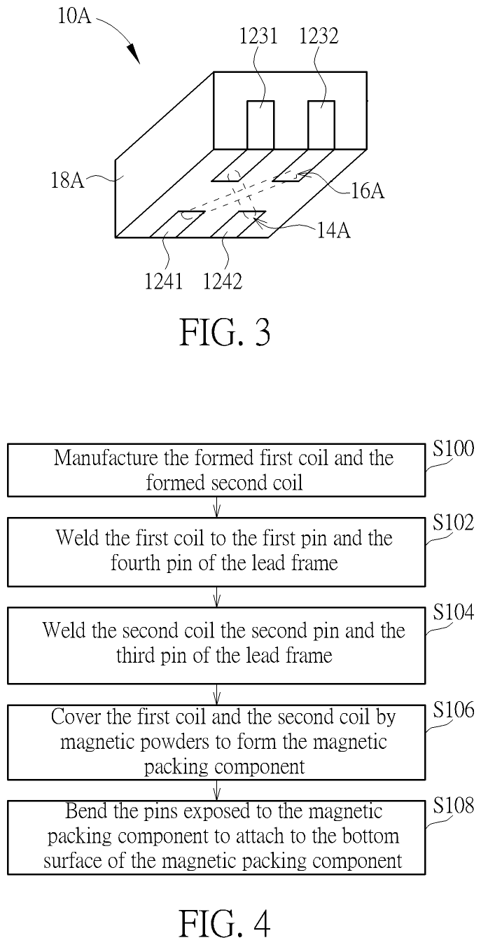

Please refer to FIG. 1 to FIG. 3. FIG. 1 is a diagram of parts of an integrated-type coupled inductor 10A according to a first embodiment of the present invention. FIG. 2 is a diagram of the integrated-type coupled inductor 10A in another view according to the first embodiment of the present invention. FIG. 3 is an appearance diagram of the integrated-type coupled inductor 10A according to the first embodiment of the present invention. The integrated-type coupled inductor 10A can include a lead frame 12A, a first coil 14A, a second coil 16A and a magnetic packing component 18A. The lead frame 12A can include a first surface 121 and a second surface 122 opposite to each other, and have a first holder 123 and a second holder 124 respectively located on different positions. The first holder 123 can have a first pin 1231 and a second pin 1232. The second holder 124 can have a third pin 1241 and a fourth pin 1242. The third pin 1241 and the fourth pin 1242 respectively points towards the first pin 1231 and the second pin 1232.

The first coil 14A and the second coil 16A can be respectively disposed on the first surface 121 and the second surface 122 of the lead frame 12A. Two ends of the first coil 14A can be respectively welded to the first pin 1231 and the fourth pin 1242. Two ends of the second coil 16A can be respectively welded to the second pin 1232 and the third pin 1241. The magnetic packing component 18A can be used to cover the first coil 14A and the second coil 16A, and parts of the first pin 1231, the second pin 1232, the third pin 1241 and the fourth pin 1242 can be exposed. The exposed parts of the first pin 1231, the second pin 1232, the third pin 1241 and the fourth pin 1242 can be bent to the same direction and attached to the same outer surface of the magnetic packing component 18A, as shown in FIG. 3.

Please refer to FIG. 1 to FIG. 4. FIG. 4 is a flow chart of an manufacturing method applied to the integrated-type coupled inductor 10A according to the first embodiment of the present invention. The manufacturing method applied to the integrated-type coupled inductor 10A illustrated in FIG. 4 can be suitable for the integrated-type coupled inductor 10A shown in FIG. 1 to FIG. 3. First, step S100 can be executed to pre-manufacture the formed first coil 14A and the formed second coil 16A; the pre-manufacturing process can be any possible common process, and a detailed description is omitted herein for simplicity. Then, step S102 and step S104 can be executed to weld two ends of the first coil 12A respectively to the first pin 1231 and the fourth pin 1242 on the first surface 121 of the lead frame 12A, and turn over the lead frame 12A to weld two ends of the second coil 16A respectively to the second pin 1232 and the third pin 1241 on the second surface 122 of the lead frame 12A.

As shown in FIG. 2, the first coil 14A and the second coil 16A can be respectively located on the first surface 121 and the second surface 122 of the lead frame 12A in an opposite manner. Meanwhile, step S106 and step S108 can be executed to cover the first coil 14A and the second coil 16A by magnetic powders for forming the magnetic packing component 18A, and bend the first pin 1231, the second pin 1232, the third pin 1241 and the fourth pin 1242 of the lead frame 12A exposed to the magnetic packing component 18A for attaching to the same outer surface of the magnetic packing component 18A. Therefore, the two coils 14A and 16A connected with the exposed pins provided by the integrated-type coupled inductor 10A and the related manufacturing method of the first embodiment are interlaced, as shown in FIG. 3, and two dotted patterns can be respectively represented as pins provided by the first coil 14A and the second coil 16A.

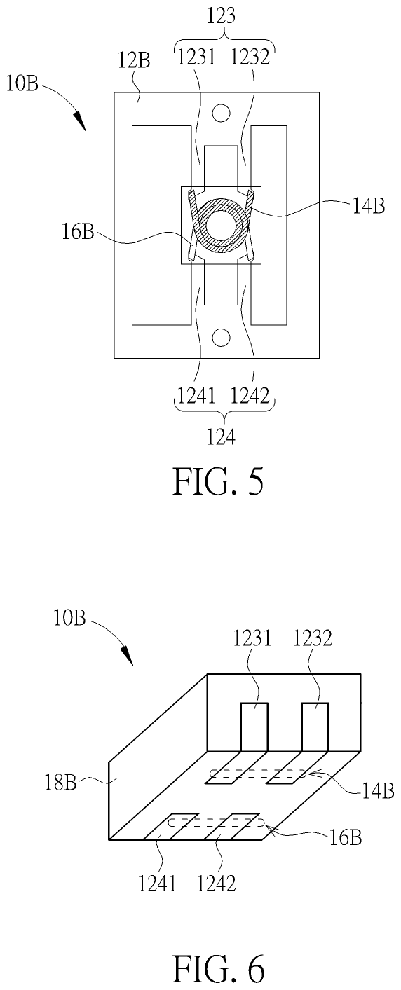

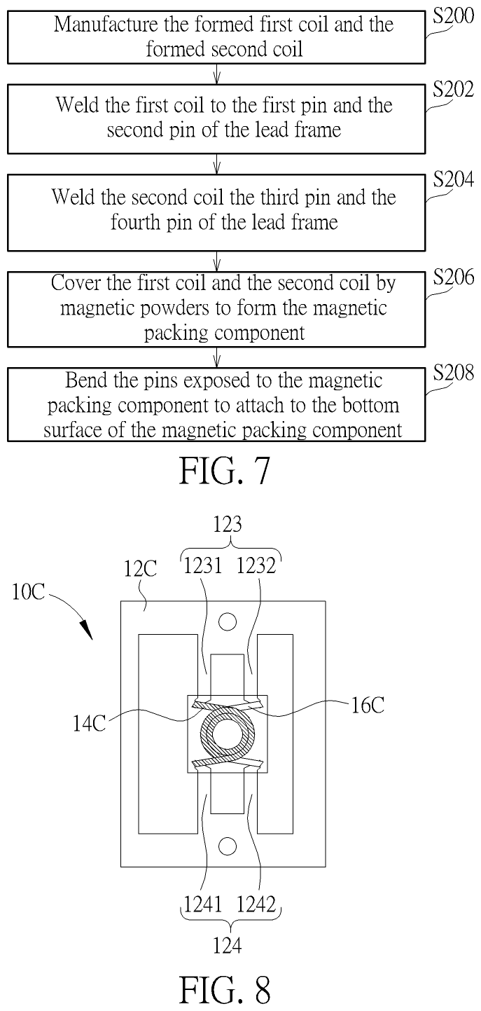

Please refer to FIG. 5 to FIG. 7. FIG. 5 is a diagram of parts of the integrated-type coupled inductor 10B according to a second embodiment of the present invention. FIG. 6 is an appearance diagram of the appearance diagram of the integrated-type coupled inductor 10B according to the second embodiment of the present invention. FIG. 7 is a flow chart of the manufacturing method applied to the integrated-type coupled inductor 10B according to the second embodiment of the present invention. The integrated-type coupled inductor 10B can include the lead frame 12B, the first coil 14B, the second coil 16B and the magnetic packing component 18B. The first holder 123 of the magnetic packing component 18B can have the first pin 1231 and the second pin 1232. The second holder 124 of the magnetic packing component 18B can have the third pin 1241 and the fourth pin 1242 respectively pointing towards the first pin 1231 and the second pin 1232.

As shown in FIG. 5, two ends of the first coil 14B can be respectively welded to the first pin 1231 and the second pin 1232, and two ends of the second coil 16B can be respectively welded to the third pin 1241 and the fourth pin 1242. The first coil 14B and the second coil 16B can be located on two opposite surfaces of the lead frame 12B. In the manufacturing method applied to the integrated-type coupled inductor 10B of the second embodiment, step S200 can be executed to pre-manufacture the formed first coil 14B and the formed second coil 16B. Then, step S202 and step S204 can be executed to weld two ends of the first coil 12B respectively to the first pin 1231 and the second pin 1232 of the lead frame 12B, and turn over the lead frame 12B to weld two ends of the second coil 16B respectively to the third pin 1241 and the fourth pin 1242. Then, step S206 and step S208 can be executed to cover the first coil 14B and the second coil 16B by the magnetic powders for forming the magnetic packing component 18B, and bend the first pin 1231, the second pin 1232, the third pin 1241 and the fourth pin 1242 exposed to the magnetic packing component 18B for attaching to the same outer surface of the magnetic packing component 18B.

The integrated-type coupled inductor 10B and the related manufacturing method of the second embodiment can weld the first coil 14B to the first pin 1231 and the second pin 1232 of the first holder 123, and weld the second coil 16B to the third pin 1241 and the fourth pin 1242 of the second holder 124. Therefore, the exposed pins 1231 and 1232 connected with the first coil 14B of the integrated-type coupled inductor 10B can be located on a front lateral side of the same outer surface of the magnetic packing component 18B, and the exposed pins 1241 and 1242 connected with the second coil 16B of the integrated-type coupled inductor 10B can be located on a rear lateral side of the same outer surface of the magnetic packing component 18B, as shown in FIG. 6; two dotted patterns can be respectively represented as pins provided by the first coil 14B and the second coil 16B.

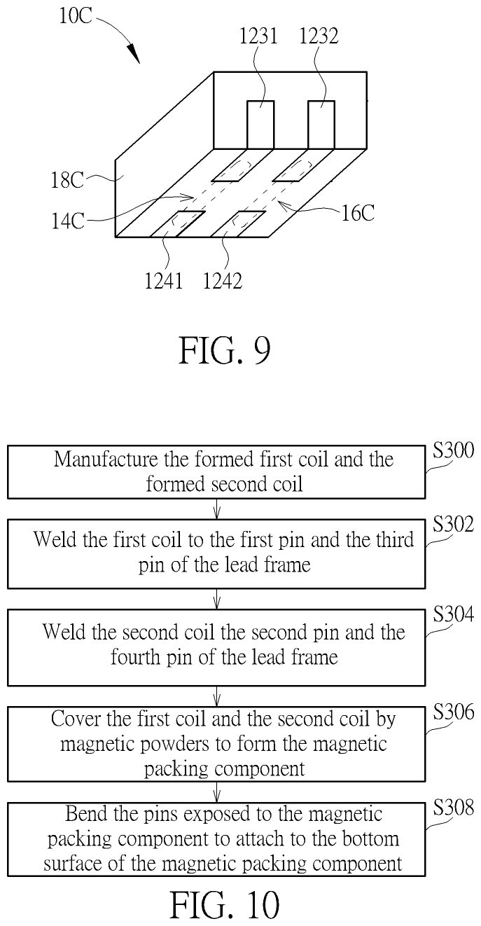

Please refer to FIG. 8 to FIG. 10. FIG. 8 is a diagram of parts of the integrated-type coupled inductor 10C according to a third embodiment of the present invention. FIG. 9 is an appearance diagram of the appearance diagram of the integrated-type coupled inductor 10C according to the third embodiment of the present invention. FIG. 10 is a flow chart of the manufacturing method applied to the integrated-type coupled inductor 10C according to the second embodiment of the present invention. The integrated-type coupled inductor 10 C can include the lead frame 12 C, the first coil 14 C, the second coil 16 C and the magnetic packing component 18 C. The first holder 123 of the magnetic packing component 18C can have the first pin 1231 and the second pin 1232. The second holder 124 of the magnetic packing component 18C can have the third pin 1241 and the fourth pin 1242 respectively pointing towards the first pin 1231 and the second pin 1232.

As shown in FIG. 8, two ends of the first coil 14C can be respectively welded to the first pin 1231 and the second pin 1232, and two ends of the second coil 16C can be respectively welded to the third pin 1241 and the fourth pin 1242. The first coil 14C and the second coil 16C can be respectively located on two opposite surfaces of the lead frame 12C. In the manufacturing method applied to the integrated-type coupled inductor 10C of the third embodiment, step S300 can be executed to pre-manufacture the formed first coil 14C and the formed second coil 16C. Then, step S302 and step S304 can be executed to weld two ends of the first coil 12C respectively to the first pin 1231 and the third pin 1241 of the lead frame 12C, and turn over the lead frame 12C to weld two ends of the second coil 16C respectively to the second pin 1232 and the fourth pin 1242. Then, step S306 and step S308 can be executed to cover the first coil 14C and the second coil 16C by the magnetic powders for forming the magnetic packing component 18C, and bend the first pin 1231, the second pin 1232, the third pin 1241 and the fourth pin 1242 exposed to the magnetic packing component 18C for attaching to the same outer surface of the magnetic packing component 18C.

The integrated-type coupled inductor 10C and the related manufacturing method of the third embodiment can weld the first coil 14C on the same side of the first holder 123 and the second holder 124, which means the first pin 1231 and the third pin 1241, and further can weld the second coil 16C to another side of the first holder 123 and the second holder 124, which means the second pin 1232 and the fourth pin 1242. Therefore, the exposed pins 1231 and 1241 connected with the first coil 14C of the integrated-type coupled inductor 10C can be located on a left lateral side of the same outer surface of the magnetic packing component 18C, and the exposed pins 1232 and 1242 connected with the second coil 16C of the integrated-type coupled inductor 10C can be located on a right lateral side of the same outer surface of the magnetic packing component 18C, as shown in FIG. 9; two dotted patterns can be respectively represented as pins provided by the first coil 14C and the second coil 16C.

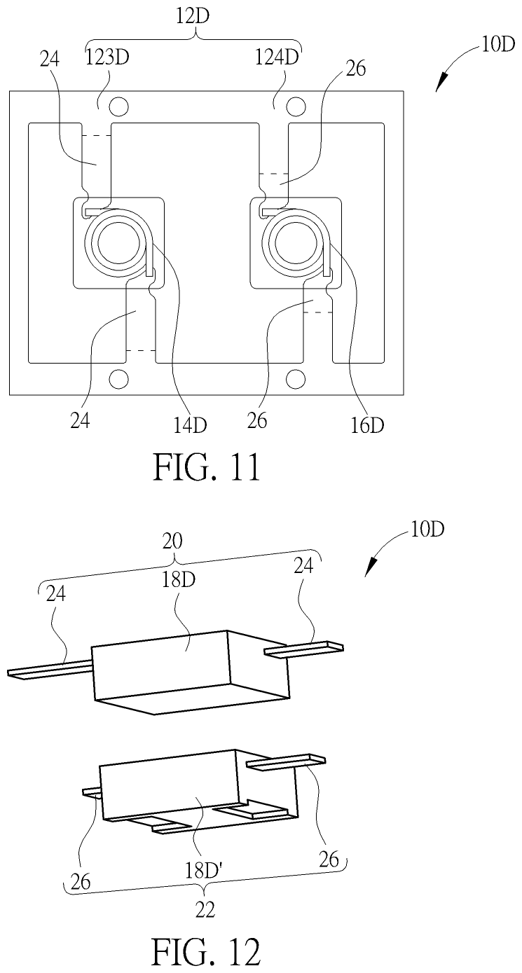

Please refer to FIG. 11 to FIG. 13. FIG. 11 is a diagram of parts of the integrated-type coupled inductor 10D according to a fourth embodiment of the present invention. FIG. 12 is a diagram of the integrated-type coupled inductor 10D before assembly according to the fourth embodiment of the present invention. FIG. 13 is an appearance diagram of the integrated-type coupled inductor 10D according to the fourth embodiment of the present invention. The integrated-type coupled inductor 10D can include the first inductor unit 20 and the second inductor unit 22, respectively having two long pins and two short pins. The long pin has a first length, and the short pin has a second length shorter than the first length. The first inductor unit 20 and the second inductor unit 22 can be stacked with each other and combined via thermosetting polymer. The long pins and the short pins can be bent to a bottom surface of the second inductor unit 22 opposite to the first inductor unit 20. The thermosetting polymer can be epoxy resin or acrylic, which depends on a design demand.

The lead frame 12D of the integrated-type coupled inductor 10D can have the first holder 123D and the second holder 124D located on different positions. The first holder 123D can have two first pins 24 respectively located on opposite and interlaced positions, and the first pins 24 can be the long pins (which are cut at a dotted line) of the first inductor unit 20 and welded to the first coil 14D, and the magnetic packing component 18D can be applied to form the first inductor unit 20. The second holder 124D can have two second pins 26 respectively located on opposite and interlaced positions, and the second pins 26 can be the short pins (which are cut at a dotted line) of the second inductor unit 22 and welded to the second coil 16D, and the magnetic packing component 18D′ can be applied to form the second inductor unit 22. The two first pins 24 of the first inductor unit 20 can be respectively located on two opposite lateral sides of the first inductor unit 20, and individually located on two different ends of the two opposite lateral sides of the first inductor unit 20. The two second pins 26 of the second inductor unit 22 can be respectively located on two opposite lateral sides of the second inductor unit 22, and individually located on two different ends of the two opposite lateral sides of the second inductor unit 22 interlaced to the two first pins 24, as shown in FIG. 13.

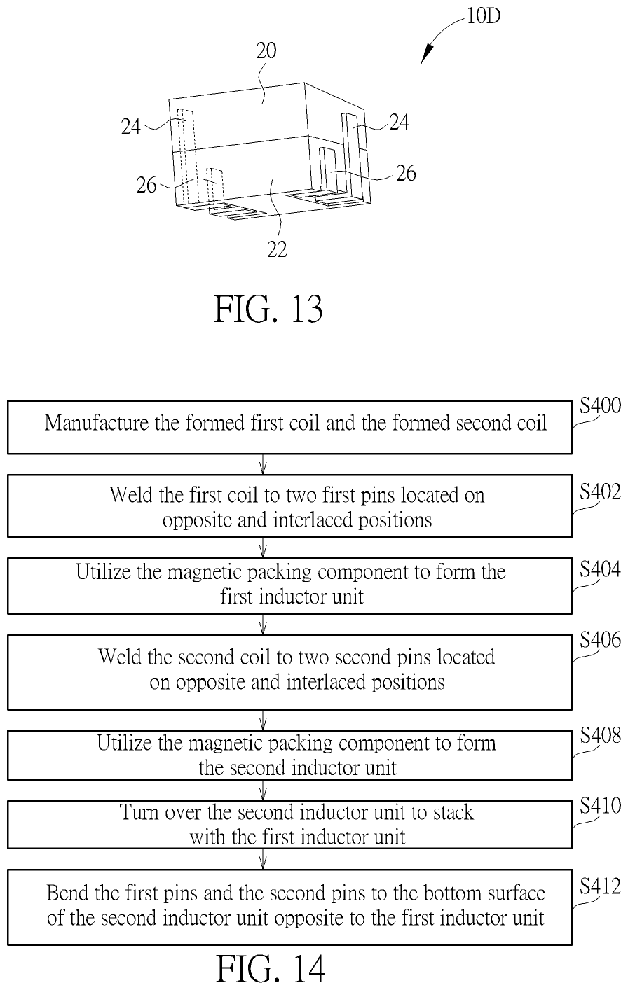

Please refer to FIG. 11 to FIG. 14. FIG. 14 is a flow chart of the manufacturing method applied to the integrated-type coupled inductor 10D according to the fourth embodiment of the present invention. The manufacturing method applied to the integrated-type coupled inductor 10D illustrated in FIG. 14 can be suitable for the integrated-type coupled inductor 10D shown in FIG. 11 to FIG. 13. First, step S400 can be executed to manufacture the formed first coil 14D and the formed second coil 16D. Then, step S402 and step S404 can be executed to weld the first coil 14D to the two first pins 24 of the lead frame 12D, and utilize the magnetic packing component 18D to cover the first coil 14D for forming the first inductor unit 20; later, step S406 and step S408 can be executed to weld the second coil 16D to the two second pins 26 of the lead frame 12D, and utilize the magnetic packing component 18D′ to cover the second coil 16D for forming the second inductor unit 22. Final, step S410 and step S412 can be executed to turn over the second inductor unit 22 for stacking with the first inductor unit 20, and further to bend the first pin 24 and the second pin 26 to the bottom surface of the second inductor unit 22 opposite to the first inductor unit 20, as shown in FIG. 13.

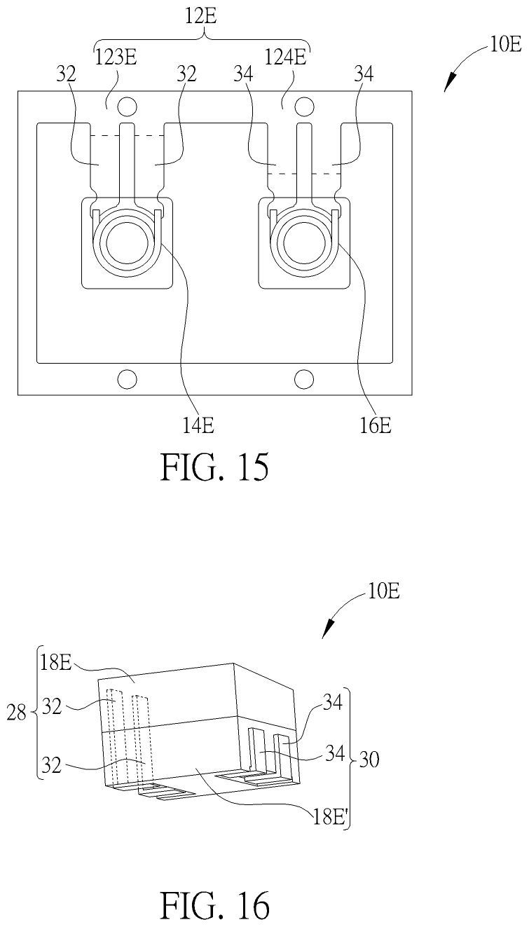

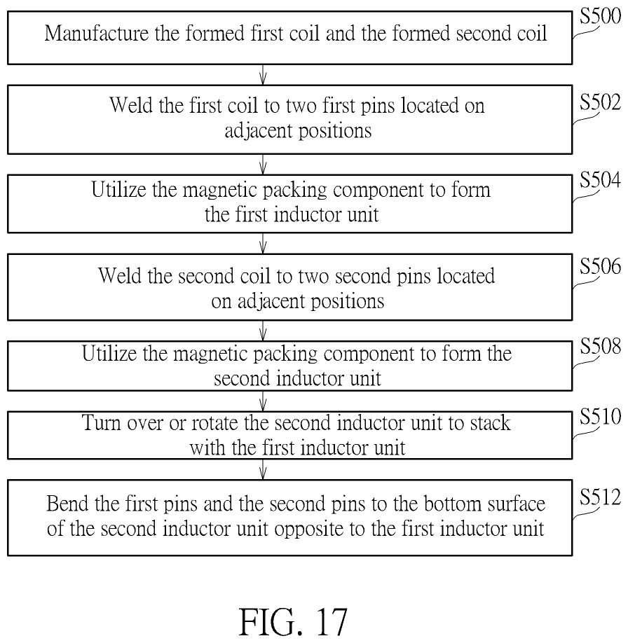

Please refer to FIG. 15 to FIG. 17. FIG. 15 is a diagram of parts of the integrated-type coupled inductor 10E according to a fifth embodiment of the present invention. FIG. 16 is an appearance diagram of the integrated-type coupled inductor 10E according to the fifth embodiment of the present invention. FIG. 17 is a flow chart of the manufacturing method applied to the integrated-type coupled inductor 10E according to the fifth embodiment of the present invention. The integrated-type coupled inductor 10E can include a first inductor unit 28 and a second inductor unit 30, respectively having two long pins and two short pins. The lead frame 12E of the integrated-type coupled inductor 10E can have the first holder 123E and the second holder 124E located on different positions. The first holder 123E can have two first pins 32 located on adjacent positions, and set as the long pins (which are cut at a dotted line) of the first inductor unit 28 and welded to the first coil 14E, and can be covered by the magnetic packing component 18E to form the first inductor unit 28. The second holder 124E can have two second pins 34 located on adjacent positions, and set as the short pins (which are cut at a dotted line) of the second inductor unit 30 and welded to the second coil 16E, and can be covered by the magnetic packing component 18E′ to form the second inductor unit 30.

The two first pins 32 of the first inductor unit 28 can be located on the same lateral side of the first inductor unit 28, and individually located on two different ends of the lateral side; the two second pins 34 of the second inductor unit 30 can be located on the same lateral side of the second inductor unit 30 opposite to the two first pins 32, and individually located on two different ends of the lateral side, as shown in FIG. 16. In the manufacturing method applied to the integrated-type coupled inductor 10E of the fifth embodiment, step S500 can be executed to manufacture the formed first coil 14E and the formed second coil 16E. Then, step S502 and step S504 can be executed to weld the first coil 14E to the two first pins 32 of the lead frame 12E, and utilize the magnetic packing component 18E to cover the first coil 14E for forming the first inductor unit 28; later, step S506 and step S508 can be executed to weld the second coil 16E to the two second pins 34 of the lead frame 12E, and utilize the magnetic packing component 18E′ to cover the second coil 16E for forming the second inductor unit 30. Final, step S510 and step S512 can be executed to turn over or rotate the second inductor unit 30 to stack with the first inductor unit 28, and further to bend the first pin 32 and the second pin 34 to the bottom surface of the second inductor unit 30 opposite to the first inductor unit 28, as shown in FIG. 16.

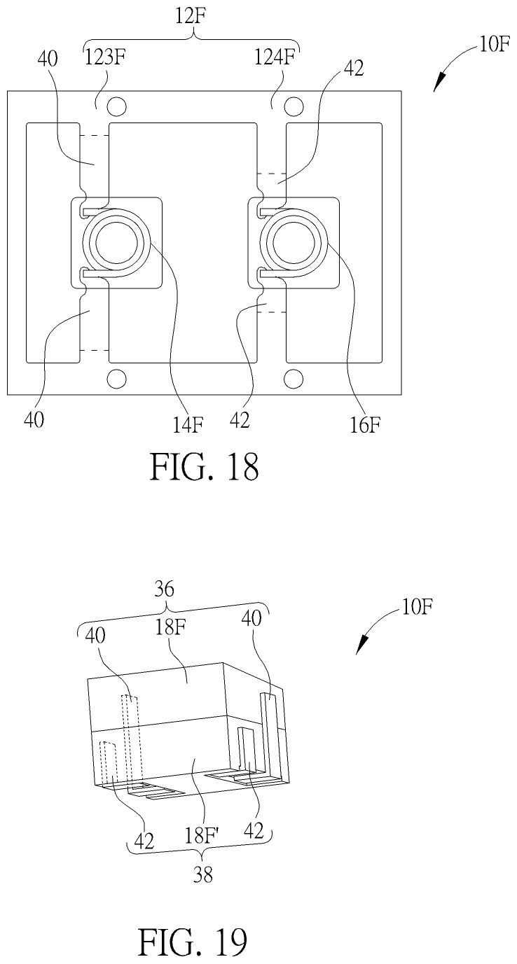

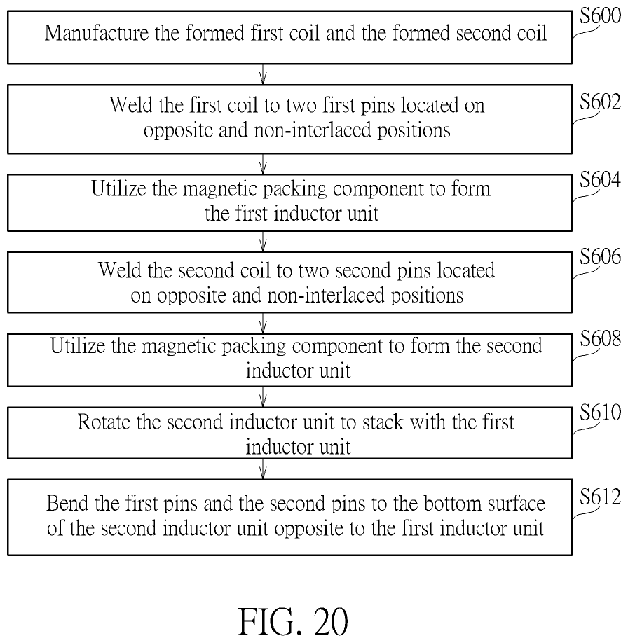

Please refer to FIG. 18 to FIG. 20. FIG. 18 is a diagram of parts of the integrated-type coupled inductor 10F according to a sixth embodiment of the present invention. FIG. 19 is an appearance diagram of the integrated-type coupled inductor 10F according to the sixth embodiment of the present invention. FIG. 20 is a flow chart of the manufacturing method applied to the integrated-type coupled inductor 10F according to the sixth embodiment of the present invention. The integrated-type coupled inductor 10F can include a first inductor unit 36 and a second inductor unit 38, respectively having two long pins and two short pins. The lead frame 12F of the integrated-type coupled inductor 10F can have the first holder 123F and the second holder 124F located on different positions. The first holder 123F can have two first pins 40 located on opposite positions, and set as the long pins (which are cut at a dotted line) of the first inductor unit 36 and welded to the first coil 14F, and can be covered by the magnetic packing component 18F to form the first inductor unit 36. The second holder 124F can have two second pins 42 located on opposite positions, and set as the short pins (which are cut at a dotted line) of the second inductor unit 38 and welded to the second coil 16F, and can be covered by the magnetic packing component 18F′ to form the second inductor unit 38.

The two first pins 40 of the first inductor unit 36 can be respectively located on two opposite sides of the first inductor unit 36, and individually located on the same end of the two opposite sides of the first inductor unit 36; the two second pins 42 of the second inductor unit 38 can be respectively located on two opposite sides of the second inductor unit 38, and individually located on the same end of the two opposite sides of the second inductor unit 38 different from the two first pins 40, as shown in FIG. 19. In the manufacturing method applied to the integrated-type coupled inductor 10F of the sixth embodiment, step S600 can be executed to manufacture the formed first coil 14F and the formed second coil 16F. Then, step S602 and step S604 can be executed to weld the first coil 14F to the two first pins 40 of the lead frame 12F, and utilize the magnetic packing component 18F to cover the first coil 14F for forming the first inductor unit 36; later, step S606 and step S608 can be executed to weld the second coil 16F to the two second pins 42 of the lead frame 12F, and utilize the magnetic packing component 18F′ to cover the second coil 16F for forming the second inductor unit 38. Final, step S610 and step S612 can be executed to rotate the second inductor unit 38 to stack with the first inductor unit 36, and further to bend the first pin 40 and the second pin 42 to the bottom surface of the second inductor unit 38 opposite to the first inductor unit 36, as shown in FIG. 19.

In conclusion, the integrated-type coupled inductor and the related manufacturing method of the present invention can utilize the mechanical stripping process or the laser stripping process to remove the isolation layers of the first coil and the second coil. The coils without the isolation layer can be respectively welded to the pins of different holders in accordance with demands of each embodiment, and then soft magnetic powders, such as iron silicon chromium alloy, iron silicon alloy or amorphous alloy, can be utilized to form the magnetic packing component for accomplishing the integrated-type coupled inductor. The manufacturing method of the present invention can be used to manufacture the integrated-type coupled inductor for different circuit design, and have advantages of low cost and stable process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated-type coupled inductor, comprising:
a lead frame having a first surface and a second surface opposite to each other and comprising four pins;
a first coil disposed on the first surface, two ends of the first coil being respectively coupled to two of the four pins;
a second coil disposed on the second surface, two ends of the second coil being respectively coupled to two other pins of the four pins; and
a magnetic packing component covering the first coil and the second coil to expose parts of the four pins.

2. The integrated-type coupled inductor of claim 1, wherein the lead frame comprises a first holder and a second holder located on different positions, the first holder comprises a first pin and a second pin, the second holder comprises a third pin and a fourth pin respectively pointing towards the first pin and the second pin, the first coil is welded to the first pin and the fourth pin, the second coil is welded to the second pin and the third pin.

3. The integrated-type coupled inductor of claim 1, wherein the lead frame comprises a first holder and a second holder located on different positions, the first holder comprises a first pin and a second pin, the second holder comprises a third pin and a fourth pin respectively pointing towards the first pin and the second pin, the first coil is welded to the first pin and the second pin, the second coil is welded to the third pin and the fourth pin.

4. The integrated-type coupled inductor of claim 1, wherein the lead frame comprises a first holder and a second holder located on different positions, the first holder comprises a first pin and a second pin, the second holder comprises a third pin and a fourth pin respectively pointing towards the first pin and the second pin, the first coil is welded to the first pin and the third pin, the second coil is welded to the second pin and the fourth pin.

5. The integrated-type coupled inductor of claim 1, wherein the first coil and the second coil are welded after isolation layers is removed via a mechanical stripping process or a laser stripping process.

6. A manufacturing method applied to an integrated-type coupled inductor, the manufacturing method comprising:
manufacturing and forming a first coil and a second coil;
welding two ends of the first coil respectively to two pins on a first surface of a lead frame;
welding two ends of the second coil respectively to two other pins on a second surface of the lead frame opposite to the first surface; and
covering the first coil and the second coil via a magnetic packing component to expose parts of the four pins of the lead frame.

7. The manufacturing method of claim 6, wherein the lead frame comprises a first holder and a second holder located on different positions, the first holder comprises a first pin and a second pin, the second holder comprises a third pin and a fourth pin respectively pointing towards the first pin and the second pin, the manufacturing method further comprises:
welding the first coil to the first pin and the fourth pin; and
turning over the lead frame to weld the second coil to the second pin and the third pin.

8. The manufacturing method of claim 6, wherein the lead frame comprises a first holder and a second holder located on different positions, the first holder comprises a first pin and a second pin, the second holder comprises a third pin and a fourth pin respectively pointing towards the first pin and the second pin, the manufacturing method further comprises:
welding the first coil to the first pin and the second pin; and
turning over the lead frame to weld the second coil to the third pin and the fourth pin.

9. The manufacturing method of claim 6, wherein the lead frame comprises a first holder and a second holder located on different positions, the first holder comprises a first pin and a second pin, the second holder comprises a third pin and a fourth pin respectively pointing towards the first pin and the second pin, the manufacturing method further comprises:
welding the first coil to the first pin and the third pin; and
turning over the lead frame to weld the second coil to the second pin and the fourth pin.

10. The manufacturing method of claim 6, further comprising:
removing isolation layers of the first coil and the second coil via a mechanical stripping process or a laser stripping process.

11. An integrated-type coupled inductor, comprising:
a first inductor unit, a first coil being disposed inside the first inductor unit and two long pins with a first length being exposed;
a second inductor unit attached to the first inductor, a second coil being disposed inside the second inductor unit and two short pins with a second length being exposed, the second length being shorter than the first length, the two long pins and the two short pins being bent to a bottom surface of the second inductor unit opposite to the first inductor unit.

12. The integrated-type coupled inductor of claim 11, wherein the two long pins are respectively located on two opposite lateral sides of the first inductor unit and further individually located on two different ends of the two opposite lateral sides of the first inductor unit, the two short pins are respectively located on two opposite lateral sides of the second inductor unit and further individually located on two different ends of the two opposite lateral sides of the second inductor unit interlaced to the two long pins.

13. The integrated-type coupled inductor of claim 11, wherein the two long pins are located on a lateral side of the first inductor unit and individually located on two different ends of the lateral side of the first inductor unit, the two short pins are located on a lateral side of the second inductor unit opposite to the two long pins and individually located on two different ends of the lateral side of the second inductor unit.

14. The integrated-type coupled inductor of claim 11, wherein the two long pins are respectively located on two opposite lateral sides of the first inductor unit and further individually located on the same end of the two opposite lateral sides of the first inductor unit, the two short pins are respectively located on two opposite lateral sides of the second inductor unit and further individually located on the same end of the two opposite lateral sides of the second inductor unit different from the two long pins.

15. The integrated-type coupled inductor of claim 11, wherein isolation layers of the first coil and the second coil are removed via a mechanical stripping process or a laser stripping process and then applied for manufacturing the first inductor unit and the second inductor unit.

16. A manufacturing method applied to an integrated-type coupled inductor, the manufacturing method comprising:
manufacturing and forming a first coil and a second coil;
welding the first coil to two long pins of a lead frame and then utilizing a magnetic packing component to cover the first coil for forming a first inductor unit;
welding the second coil to two short pins of the lead frame and then utilizing another magnetic packing component to cover the second coil for forming a second inductor unit;
stacking the first inductor unit with the second inductor unit; and
bending the two long pins and the two short pins to a bottom surface of the second inductor unit opposite to the first inductor unit;
wherein the long pin has a first length longer than a second length of the short pin.

17. The manufacturing method of claim 16, wherein the lead frame comprises a first holder and a second holder located on different positions, the first holder comprises two first pins respectively located on opposite and interlaced positions, the second holder comprises two second pins respectively located on opposite and interlaced positions, the manufacturing method further comprises:
welding two ends of the first coil respectively to the two first pins for being the two long pins;
welding two ends of the second coil respectively to the two second pins for being the two short pins; and
turning over the second inductor unit to stack with the first inductor unit.

18. The manufacturing method of claim 16, wherein the lead frame comprises a first holder and a second holder located on different positions, the first holder comprises two first pins respectively located on adjacent positions, the second holder comprises two second pins respectively located on adjacent positions, the manufacturing method further comprises:
welding two ends of the first coil respectively to the two first pins for being the two long pins;
welding two ends of the second coil respectively to the two second pins for being the two short pins; and
turning over or rotating the second inductor unit to stack with the first inductor unit.

19. The manufacturing method of claim 16, wherein the lead frame comprises a first holder and a second holder located on different positions, the first holder comprises two first pins respectively located on opposite positions, the second holder comprises two second pins respectively located on opposite positions, the manufacturing method further comprises:
welding two ends of the first coil respectively to the two first pins for being the two long pins;
welding two ends of the second coil respectively to the two second pins for being the two short pins; and
rotating the second inductor unit to stack with the first inductor unit.

20. The manufacturing method of claim 16, further comprising:
removing isolation layers of the first coil and the second coil via a mechanical stripping process or a laser stripping process.
